(19) United States
(12) Patent Application Publication
(10) Pub. No.: US 2025/0348730 A1
(43) Pub. Date: Nov. 13, 2025

(54) SYSTEM AND METHOD OF ADAPTING FLOATING-POINT CONTAINERS OF TRAINING DATA FOR TRAINING ARTIFICIAL NEURAL NETWORKS

(71) Applicant: THE GOVERNING COUNCIL OF THE UNIVERSITY OF TORONTO, Toronto (CA)

(72) Inventors: Milos NIKOLIC, Toronto (CA); Enrique TORRES SANCHEZ, Zaragoza (ES); Andreas MOSHOVOS, North York (CA)

(21) Appl. No.: 18/661,566

(22) Filed: May 10, 2024

(51) Int. Cl. G06N 3/08; G06F 7/499

(52) U.S. Cl. CPC G06N 3/08; G06F 7/49915

(57) ABSTRACT

Provided is a system and method a computer-implemented method of adapting floating-point containers of training data for training an artificial neural network, the method including: receiving the training data for training the artificial neural network; determining an adapted mantissa bitlength for the training data comprising determining a required number of bits in the mantissas and trimming least significant bits from the mantissas to arrive at the determined number of bits, determining an adapted exponent bitlength for the training data comprising determining a required number of bits in the exponents of the training data and trimming the most significant bits from the exponents to arrive at the determined number of bits, or determining both; and storing the training data with the adapted mantissa bitlengths, the adapted exponent bitlengths, or both. In some cases, the adapted exponents are stored in groups after trimming their bitlengths to fit the value content.

### TECHNICAL FIELD

The following relates, generally, to deep learning; and more particularly, to a system and method of adapting floating-point containers of training data for training artificial neural networks.

### BACKGROUND

Training of machine learning models or artificial neural networks is generally expensive both computationally and memory-wise. However, it is the memory transfers to off-chip memory accesses for stashing (i.e., saving and much later recovering) activation and weight tensors that generally dominate execution time and energy because computing the weight updates necessitates retrieving the activations from the forward pass. For example, for ResNet18 on ImageNet, with a batch size of 256 images, the volume of activations is on the order of gigabytes far exceeding practical on-chip capacities. In this way, the per batch data volume generally surpasses on-chip memory capacities, necessitating off-chip DRAM accesses which are up to two orders of magnitude slower and more energy expensive.

The most direct way to reduce tensor volume is by using data types which use fewer bits per value, e.g., BFloat16, half-precision floating-point (FP16), dynamic floating-point, flexpoint, or even fixed-point. This reduces memory traffic and footprint, improving energy efficiency and execution times. Training typically uses single precision 32-bit floating-point (FP32), as it is believed to yield the best accuracy. However, recent research has shown that using more compact data types can still achieve good results while reducing memory usage. For example, using 8b and 4b data types in certain cases. Alternatively, for example, using 8-bit floating point with different mantissa/exponent ratios to meet the specific needs of tensors and even shorted formats. However, even with efficient datatypes, a number of significant challenges remain.

### SUMMARY

In an aspect, there is provided a computer-implemented method of adapting floating-point containers of training data for training an artificial neural network, the method comprising: receiving the training data for training the artificial neural network; determining an adapted mantissa bitlength for the training data comprising determining a required number of bits in the mantissas and trimming least significant bits from the mantissas to arrive at the determined number of bits, determining an adapted exponent bitlength for the training data comprising determining a required number of bits in the exponents of the training data and trimming the most significant bits from the exponents to arrive at the determined number of bits, or determining both; and storing the training data with the adapted mantissa bitlengths, the adapted exponent bitlengths, or both.

In a particular case of the method, the required number of bits in the mantissa, the required number of bits in the exponent, or both, are determined using gradient descent.

In another case of the method, gradient descent is performed on a per-tensor basis and applied to each activation and weight tensor separately.

In yet another case of the method, gradient descent is performed with a loss used to penalize mantissa bitlengths, exponent bitlengths, or both, by adding a weighted average of the volume, by weighting a sum based on number of operations on each tensor, or based on a weighted sum of squares.

In yet another case of the method, determining the required number of bits in the exponents of the training data is determined by parameterizing a range of the exponents, taking partial derivatives of the parameterized range, and determining an exponent bit length gradient using a range for the exponents determined from the partial derivatives.

In yet another case of the method, determining the required number of bits in the mantissa, or the required number of bits in the exponent, using gradient descent comprises stochastically selecting between two nearest integers.

In yet another case of the method, the required number of bits in the mantissa is determined by tracking a loss function and using the loss function to determine whether to add, remove, or keep the same the mantissa bitlength.

In yet another case of the method, the required number of bits in the exponent is determined by tracking a loss function and using the loss function to determine whether to increase, decrease, or keep the same range of exponent values.

In yet another case of the method, the required number of bits in the exponent is determined by determining a magnitude based on a favorable distribution determined using delta encoding.

In yet another case of the method, the required number of bits in the exponent is further determined using a bias that is determined from a distribution of exponent values over a group of values.

In another aspect, there is provided a system of adapting floating-point containers of training data for training an artificial neural network, the system comprising a processing unit and a data storage, the data storage comprising instructions for the processing unit to execute: an input module to receive the training data for training the artificial neural network; a mantissa module to determine an adapted mantissa bitlength for the training data comprising determining least significant bits in the mantissas and trimming the least significant bits from the mantissas, an exponent module to determine an adapted exponent bitlength for the training data comprising determining least significant bits in the exponents of the training data and trimming the least significant bits from the exponents, or both the mantissa module and the exponent module; and an output module to store the training data with the adapted mantissa bitlengths, the adapted exponent bitlengths, or both.

In a particular case of the system, the required number of bits in the mantissa, the required number of bits in the exponent, or both, are determined using gradient descent.

In another case of the system, gradient descent is performed on a per-tensor basis and applied to each activation and weight tensor separately.

In yet another case of the system, gradient descent is performed with a loss used to penalize mantissa bitlengths, exponent bitlengths, or both, by adding a weighted average of the volume, by weighting a sum based on number of operations on each tensor, or based on a weighted sum of squares.

In yet another case of the system, the exponent module determines the required number of bits in the exponents of the training data by parameterizing a range of the exponents, taking partial derivatives of the parameterized range, and determining an exponent bit length gradient using a range for the exponents determined from the partial derivatives.

In yet another case of the system, determining the required number of bits in the mantissa, or the required number of bits in the exponent, using gradient descent comprises stochastically selecting between two nearest integers.

In yet another case of the system, the required number of bits in the mantissa is determined by tracking a loss function and using the loss function to determine whether to add, remove, or keep the same the mantissa bitlength.

In yet another case of the system, the required number of bits in the exponent is determined by tracking a loss function and using the loss function to determine whether to increase, decrease, or keep the same range of exponent values.

In yet another case of the system, the processing unit comprises encoders to trim the training data using the adapted mantissa bitlengths, the adapted exponent bitlengths, or both, and comprises decoders to expand the training data to the original format.

In yet another case of the system, the encoder comprises one or more packers that each receive a number and masks unused mantissa bits based on the adapted mantissa bitlengths and unused exponent bits based on the adapted exponent bitlengths.

These and other aspects are contemplated and described herein. It will be appreciated that the foregoing summary sets out representative aspects of the system and method to assist skilled readers in understanding the following detailed description.

### BRIEF DESCRIPTION OF THE DRAWINGS

The features of the invention will become more apparent in the following detailed description in which reference is made to the appended drawings wherein:

FIG. 1 is a diagram showing a system of adapting floating-point containers of training data for training artificial neural networks, in accordance with an embodiment;

FIG. 2 is a flowchart showing a method of adapting floating-point containers of training data for training artificial neural networks, in accordance with an embodiment;

FIG. 3 is a chart showing validation accuracy for Quantum Mantissa and Quantum Exponent for the system of FIG. 1 on ResNet18/ImageNet throughout training;

FIG. 4 is a chart showing weighted mantissa bitlengths with their spread for Quantum Mantissa and Quantum Exponent for the system of FIG. 1 on ResNet18/ImageNet throughout training;

FIG. 5 is a chart showing weighted exponent bitlengths with their spread for Quantum Mantissa and Quantum Exponent for the system of FIG. 1 on ResNet18/ImageNet throughout training;

FIG. 6 is a chart showing weighted total bitlengths with their spread for Quantum Mantissa and Quantum Exponent for the system of FIG. 1 on ResNet18/ImageNet throughout training;

FIG. 7 is a chart showing validation accuracy for BitWave for the system of FIG. 1 on ResNet18/ImageNet throughout training;

FIG. 8 is a chart showing average mantissa and exponent bitlengths per epoch throughout training for BitWave for the system of FIG. 1;

FIG. 9 is a chart showing cumulative distribution of exponent values for Gecko on ResNet18/ImageNet for the system of FIG. 1;

FIG. 10 is a chart showing cumulative distribution of exponent values for Gecko on ResNet18/ImageNet for the system of FIG. 1;

FIG. 11 is a chart showing post-encoding distribution of exponent bitlength for Gecko on ResNet18/ImageNet for the system of FIG. 1;

FIG. 12 is a table showing SFP_{BW}, SFP_{Q}, and BF16 accuracy, perplexity, and total memory reduction of the system of FIG. 1 compared to FP32;

FIG. 13 illustrates an example schematic for a compressor in accordance with a hardware implementation of the system of FIG. 1;

FIG. 14 illustrates an example schematic for a decompressor in accordance with a hardware implementation of the system of FIG. 1;

FIG. 15 illustrates an example schematic for a packer in accordance with a hardware implementation of the system of FIGS. 1; and

FIG. 16 illustrates an example schematic for an unpacker in accordance with a hardware implementation of the system of FIG. 1.

### DETAILED DESCRIPTION

Embodiments will now be described with reference to the figures. For simplicity and clarity of illustration, where considered appropriate, reference numerals may be repeated among the FIGs to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

Data movement has emerged as the main bottleneck in both performance and energy for training modern machine learning models, namely deep neural networks. A common approach to alleviate this issue is to use narrower numerical data types, such as fp16 and fp8. Nevertheless, such approaches often resort to static selection of data types and rely on trial and error; thereby, leading to time-consuming processes and suboptimal reductions in data movement.

The transfer of tensors to and from memory during neural network training generally dominates time and energy. To improve energy efficiency and performance, certain narrower data representations can be used. So far, narrower data representations relied on user-directed trial-and-error to achieve convergence. The present embodiments advantageously relieve users from this responsibility. Methods described herein dynamically adjust the size and format of the floating-point containers used for activations and weights during training, achieving adaptivity across three dimensions: i) which datatype to use, ii) on which tensor, and iii) how it changes over time. The different meanings and distributions of exponent and mantissas advantageously allow for tailored approaches for each. Lossy pairs of methods are provided to eliminate as many mantissa and exponent bits as possible without affecting accuracy. Informally referred to as ‘Quantum Mantissa’ and ‘Quantum Exponent’, such approaches are machine learning compression methods that tap into the gradient descent algorithm to learn the minimal mantissa and exponent bitlengths on a per-layer granularity. The models automatically learn that many tensors can use just 1 or 2 mantissa bits and 3 or 4 exponent bits. Example experiments illustrate that the two machine learning approaches can reduce the footprint by 4.73 times. In another approach, informally referred to as ‘BitWave’, changes in the loss function are observed during training to adjust mantissa and exponent bitlengths network-wide, yielding a 3.17 times reduction in footprint. In another approach, informally referred to as ‘Gecko’, the naturally emerging, lop-sided exponent distribution is exploited to losslessly compress resulting exponents from Quantum Exponent or BitWave and, on average, improve compression rates to 5.61 times and 4.53 times, respectively.

The question of which training datatype strikes the right balance among accuracy, energy and time is a difficult problem in the art. There has been limited success in training with more compact floating-point such as half-precision FP16 and BFloat16. These approaches can match single-precision (FP32) accuracy and provide significant cost reduction; however, they are still over-provisioned and leave potential unexploited. There has been limited success at using very small datatypes with 8 b and 4 b, which is at extremes for some cases. Similarly, hardware design can be investigated in how to use narrower floating point with different mantissa/exponent ratios according to perceived needs of tensors. These datatypes are often tailored to specific network architectures and current selection approaches cannot match FP32 accuracy outside of a narrow subset of shallow networks. Other energy efficient datatypes have been proposed including dynamic floating-point, flexpoint, hybrid block floating-point, and combinations with other datatypes like fixed-point. These tailored methods require careful trial-and-error investigation of where, when, and which datatypes to use. This is challenging because different tensors, tasks, architectures, or layers require different datatypes. The methods require full trial-and-error training runs and post mortem analysis as whether the choice of datatypes is viable. Moreover, since the datatypes are statically chosen they offer no opportunity to amend the choice if accuracy suffers (e.g., significant drop with deeper networks).

Adaptable methods can also be used. Open-loop methods modify the datatype based on a predetermined schedule but require trail-and-error runs to find an adequate schedule. Closed-loop solutions that monitor some metric other than loss or task accuracy (e.g., quantization error) comparing against a preset allowable error schedule (based on time, layer depth, or other network features) run into the same issue. Other approaches determine leaner datatypes to use in mixed-precision fixed-point quantization for activations. It periodically determines the maximum permissible quantization error bound for each activation tensor based on a user-selected maximum allowable increase in loss and adjusts the bitlength they use. However, such approaches can not compress weights and is not applicable where weights dominate such as most natural language processing networks. Determining the permissible bounds is also expensive, however, its overhead can be kept down by performing it infrequently.

Generally, current approaches for expanding support for efficient datatypes have a number of substantial challenges and disadvantages, for example:
To achieve convergence, current approaches rely exclusively on trial-and-error. In this way, it is up to the user to carefully select which datatype to use for each tensor. This often necessitates changes to the training recipe and the inclusion of additional operations such as loss scaling. Convergence is not guaranteed and can be evaluated only post mortem.
Universally, such approaches store weights in full-precision as the backward pass performs minuscule updates that cannot be represented with the leaner datatype.
The datatypes are statically chosen offering no opportunity to amend the choice if accuracy suffers (e.g., significant drop with deeper networks),.
Even where successful, these methods still use a scant repertoire of bitlengths (e.g., tensors fitting in 5 b have to use 8 b, a nearly 2× increase), leaving a lot of opportunity for memory overhead reduction untapped.
Such approaches require hardware changes to allow computation with the leaner datatypes.

In contrast, the present embodiments harness the training process itself to automatically learn bitlengths by automatically tailoring datatypes to each tensor, layer, and network, and continuously adjusting them as training progresses; adapting to the changing needs. The present embodiments automate and fuse into training itself the process of datatype discovery. This improves execution time and energy efficiency. Given that floating-point remains the datatype of choice to ensure convergence, automatic floating-point datatype selection is used with the goal being to reduce memory traffic during training. In this way, the present embodiments can:
dynamically and continuously adjust the mantissa and the exponent bitlengths for floating-point activations and/or weights for stashed tensors, and do so transparently at no additional burden to the user;
be adaptable across three dimensions: The first two automate what is currently done by hand: which datatype to use for which tensor; and adapt these datatypes over time;
adapt the exponent bitlengths to their actual content using only as many bits as necessary to store their value such that most exponents use a lot fewer bits than statically selected datatype;
store values in memory with only as many bits as necessary while expanding values to the closest available datatype supported by the accelerator;
in addition to accelerating training, inform efforts for selecting more efficient datatypes for inference; and
as a by-product, quantize the networks to efficient datatypes in a way that benefits inference.

The present embodiments, as part of Quantum Mantissa and Quantum Exponent, harnesses the training algorithm itself to learn on-the-fly the per tensor mantissa and exponent bitlengths which it continuously adapts per batch. Quantum Mantissa and Quantum Exponent introduce a learning parameter per tensor and a regularizer that include the effects of the mantissa and exponent bitlength, respectively. Learning the bitlength generally incurs a negligible overhead compared to the resulting reduction in off-chip traffic. Example experiments showed that: 1) the present embodiments reduce bitlengths considerably, more so for mantissas, 2) the bitlengths can vary per tensor and 3) the bitlengths can fluctuate throughout, capturing benefits that wouldn't be possible with a static network-wide choice of datatype.

BitWave approaches the training implementation as a black-box observing the effect of adjusting mantissa and exponent bitlengths on its progress. It uses an exponential moving average of the loss (observed per-batch) to adjust the mantissa and exponent bitlengths for the whole network. As long as the network is determined to be improving, BitWave can be used to shorten the bitlengths; otherwise, it can increase them. BitWave advantageously harnesses the training process to learn the optimal bitlengths, and adjust bitlengths per layer; whereas BitWave adjusts them network-wide.

On top of the above bitlength reduction, Gecko can be used to exploit the biased distribution that naturally occurs during training by storing exponents using only as many bits as necessary to represent their magnitude and sign; which outperforms any statically chosen bitlength. The bitlength can be selected per group of values to reduce metadata overhead achieving high encoding efficiency.

Example experiments illustrate that there is a boost in energy efficiency and performance by transparently encoding values as they are being stashed to off-chip DRAM, and decoding them to their original format as they are being read back. In some cases, decompressor units can be used in front of a memory controller in order to leave the rest of the on-chip memory hierarchy and compute cores unchanged.

The example experiments illustrate that the compression techniques in the determination of the optimal mantissa and exponent bitlengths reduces overall memory footprint without noticeable loss of accuracy. Quantum Mantissa and Quantum Exponent reduce tested models by 4.73 times on average (range: 3.35×-13.23×) and BitWave by 3.17 times on average (range: 2.24×-8.91×). The example experiments demonstrate that the mantissa and exponent bitlengths vary across tensors. Gecko lossless exponent compression can further boost the footprint reduction to 5.61 times on average (range: 3.73×-17.66×) and 4.53 times on average (range: 3.07×-9.74×), respectively. The present embodiments excel at squeezing out energy savings with, 2.90 times and 2.61 times better energy efficiency for SFP_{Q+G} and SFP_{BW+G} vs BF16.

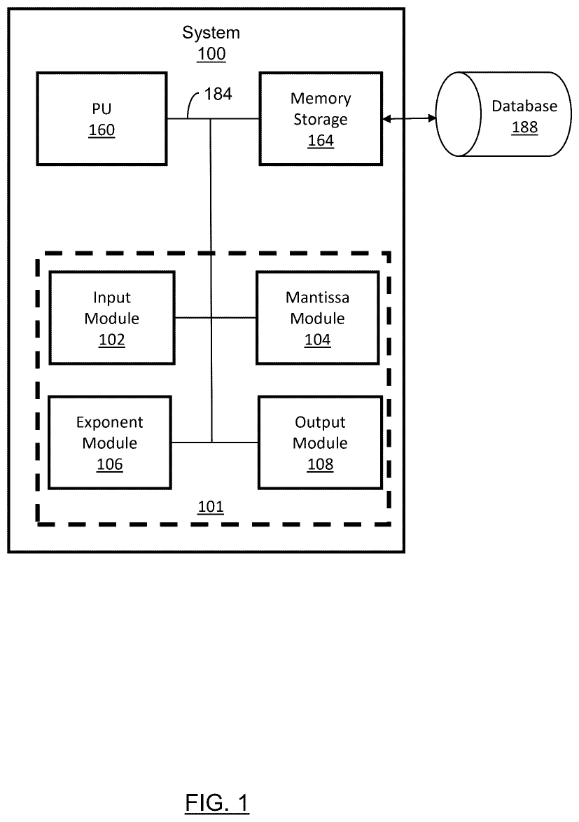

FIG. 1 illustrates a schematic diagram of a system 100 for training of a neural network with dynamic floating-point containers, according to various embodiments. As shown, the system 100 has a number of physical and logical components, including a processing unit (“PU”) 160, memory storage 164, and a local bus 184 enabling the PU 160 to communicate with the other components. PU 160 can include one or more central processing units, one or more graphical processing units, microprocessors, dedicated hardware, or other integrated processing circuits. The memory storage 164 provides relatively responsive storage to the PU 260. The PU can receive input using any suitable interface; for example, directly via a user input device, or communicated indirectly, for example, via an external device or system. Such interface module can also enable output to be provided; for example, directly via a user display, or indirectly, for example, communicated over a network. The memory storage 164 can store computer-executable instructions for implementing the methods described herein, as well as any derivative or related data. In some cases, this data can be stored in a database 188. While FIG. 1 illustrates the system 100 implemented on a single computing device, it is understood that the processing, or any of the functions undertaken by the system 100, can be distributed over multiple computing devices; for example, in a cloud or distributed computing environment.

In an embodiment, the PU 160 can be configured to execute a number of conceptual modules 101; for example, an input module 102, a mantissa module 104, an exponent module 106, and an output module 108. In further cases, functions of the above modules can be combined or executed on other modules. In some cases, functions of the above modules can be executed on remote computing devices, such as centralized servers and cloud computing resources communicating over the network module 176.

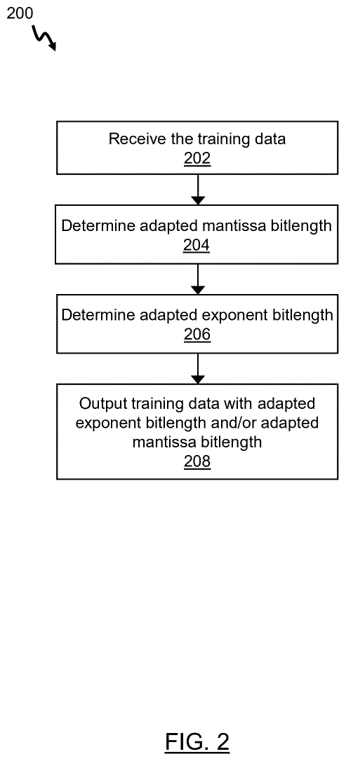

FIG. 2 illustrates a flowchart of a method 200 of adapting floating-point containers of training data for training artificial neural networks, according to an embodiment. The training data comprises floating point data and is used for training of the machine learning model.

At block 202, the input module 102 receives the training data for training the machine learning model.

At block 204, the mantissa module 104 determines an adapted mantissa bitlength for the training data by trimming the least significant bits from the mantissa. The number of mantissa bits can be determined using gradient descent to learn mantissa requirements per tensor or layer during training. In other cases, the number of mantissa bits can be determined by using activation mantissas and tracking a loss function; where, based upon the loss function, a determination can be made whether to add, remove, or keep the same mantissa bitlength.

At block 206, in some cases, the exponent module 106 determines an adapted exponent bitlength for the training data by trimming the most significant bits from the exponent. The number of exponent bits can be determined using gradient descent to learn exponent requirements per tensor or layer during training. In other cases, the exponent bitlength can be determined by determining a normal distribution of the exponent lengths using delta encoding.

At block 208, the output module 108 outputs or stores the training data with the adapted mantissa bitlengths, the adapted exponent bitlengths, or both, for training the machine learning model, to the memory storage 164 or to the database 188.

The present embodiments provide a fully automatic closed-loop approach that tracks loss and redefines mantissa and exponent quantization to make them differentiable. Additionally, the reduction of datatype size is provided as part of the objective of gradient descent, without necessitating high overhead. While closed-loop approaches for finding the most efficient datatype may exist for inference, these approaches are too expensive for training and their overheads would overshadow the benefits of a more compact training datatype. Moreover, some are specifically targeting weights or activations, and cannot adapt to different architectures where the main footprint contributors may change (weight vs activation heavy cases).

In general, maintaining accuracy on most real-world tasks requires floating-point-based training. These formats comprise a sign S, a mantissa M, and an exponent E:

$$V ( S , M , E ) = {( - 1 )}^{S} \times ( 1 + M ) \times {2}^{E} \qquad ( 1 )$$

Each part is differently distributed and requires unique approaches to effectively compress. The sign S only needs 1 bit and when V is limited to only positive numbers, it can be omitted. M, including its implied one, is the fractional part of the multiplier and, denormals aside, has a range [1,2). Reducing M's length reduces the precision of the full value. Finally, E is the exponent of the second multiplier. Reducing E's length narrows the range of the full value:

$$V ( S , M , E ) ∈ [ - {V}_{max} , - {V}_{min} ] ⋃ \{ 0 \} ⋃ [ {V}_{min} , {V}_{max} ] \qquad ( 2 )$$

where Vₘₐₓ and Vₘᵢₙ are the absolute values of the limits of V with the exponent range [Eₘᵢₙ, Eₘₐₓ] and maximum mantissa Mₘₐₓ:

$${V}_{max} = ( 1 + {M}_{max} ) \times {2}^{{E}_{max}} \qquad ( 3 )$$

$${V}_{min} = {2}^{{E}_{min}} \qquad ( 4 )$$

Quantum Mantissa and Quantum Exponent learn mantissa and exponents respectively. Both use inexpensive procedures for both the forward and backward pass of training, and make quantization differentiable and penalize the larger bitlengths in the loss function. A quantization scheme for integer mantissa and exponent bitlengths in the forward pass is provided and then expanded to the non-integer domain to allow a model (e.g., using gradient descent) to learn bitlengths. A parameterizable loss function guides this learning by penalizing larger bitlengths.

A substantial challenge for learning bitlengths is that they represent discrete values with no obvious differentiation. To overcome this, Quantum Mantissa defines quantization for non-integer bitlengths, starting with an integer quantization of the mantissa M with nₘ bits by removing all but the top nₘ bits:

$$P ( M , {n}_{m} ) = M \hat{} ( {2}^{{n}_{m}} - 1 ) << ( m - {n}_{m} ) \qquad ( 5 )$$

where P(M, nₘ) is the mantissa with bitlength nₘ, m the maximum bitlength and \hat{ } a bitwise AND.

Generally, the above does not allow the learning of bitlengths with gradient descent due to its discontinuous and non-differentiable nature. To expand the definition to real-valued nₘ=[nₘ]+{nₘ}, the values used in inference during training are stochastically selected between the nearest two integers with probabilities {nₘ} and 1−{nₘ}:

$$P ( M , {n}_{m} ) = ( \begin{matrix}P ( M , [ {n}_{m} ] ) , & w / prob . 1 - \{ {n}_{m} \} \\ P ( M , [ {n}_{m} ] + 1 ) , & w / prob . \{ {n}_{m} \}\end{matrix} \qquad ( 6 )$$

where [nₘ] and {nₘ} are floor and fractional parts of nₘ.

This mantissa approach faithfully represents the relationship between bitlength and precision in an inexpensive way. The overhead is limited to the single bitlength parameter and a random number (in the forward pass) per value group (e.g., a tensor), and a single multiply-accumulate operation (in the backward pass) per value.

For Quantum Exponent, the exponent range is parameterized as follows:

$$R ( V , {V}_{max} , {V}_{min} ) = ( \begin{matrix}- {V}_{max} , & V ∈ ( - ∞ , - {V}_{max} ) \\ V , & V ∈ [ - {V}_{max} , - {V}_{min} ] \\ - {V}_{min} , & V ∈ ( - {V}_{min} , - {V}_{min} / 2 ] \\ 0 , & V ∈ ( - {V}_{min} / 2 , {V}_{min} / 2 ) \\ {V}_{min} , & V ∈ [ {V}_{min} / 2 , {V}_{min} ) \\ V , & V ∈ [ {V}_{min} , {V}_{max} ] \\ {V}_{max} , & V ∈ ( {V}_{max} , ∞ )\end{matrix} \qquad ( 7 )$$

where Vₘₐₓ and Vₘᵢₙ are boundaries from Equation (2).

The partial derivatives of this function with respect to V, Vₘₐₓ and Vₘᵢₙ are:

$$\frac{\partial R}{\partial V} = ( \begin{matrix}0 , & V ∈ ( - ∞ , - {V}_{max} ] \\ 1 , & V ∈ ( - {V}_{max} , {V}_{max} ) \\ 0 , & V ∈ [ {V}_{max} , ∞ )\end{matrix}$$

$$\frac{\partial R}{\partial {V}_{max}} = ( \begin{matrix}- 1 , & V ∈ ( - ∞ , - {V}_{max} ] \\ 0 , & V ∈ ( - {V}_{max} , {V}_{max} ) \\ 1 , & V ∈ [ {V}_{max} , ∞ )\end{matrix}$$

$$\frac{\partial R}{\partial {V}_{min}} = ( \begin{matrix}0 , & V ∈ ( - ∞ , - {V}_{min} ] \\ - 1 , & V ∈ ( - {V}_{min} , - {V}_{min} / 2 ) \\ 1 , & V ∈ ( - {V}_{min} / 2 , 0 ) \\ - 1 , & V ∈ [ ( 0 , {V}_{min} / 2 ) \\ 1 , & V ∈ [ {V}_{min} / 2 , {V}_{min} ) \\ 0 , & {V}_{min} < V\end{matrix}$$

An exponent bit length gradient can be determined by connecting the value range with the exponent range:

$${V}_{max} = ( 1 + {M}_{max} ) \times {2}^{{E}_{max}} \qquad ( 11 )$$

$${V}_{min} = {2}^{{E}_{min}} \qquad ( 12 )$$

where Mₘₐₓ is the largest possible mantissa, Eₘₐₓ is the largest possible exponent, and Eₘᵢₙ is the smallest possible exponent. For simplicity, the exponent range can be selected to be symmetrical around 0:

$${E}_{min} = - {2}^{{n}_{e}^{i} - 1} \qquad ( 13 )$$

$${E}_{max} = {2}^{{n}_{e}^{i} - 1} - 1 \qquad ( 14 )$$

where the integer

$${n}_{e}^{i}$$

is the integer exponent bitlength. In some cases, the bias can also be learned, however, this may not be essential as the important exponents will be around 0. The definition can be expanded to the continuous domain stochastically:

$${n}_{e}^{i} = ( \begin{matrix}[ {n}_{e} ] , & w / prob . 1 - \{ {n}_{e} \} \\ [ {n}_{e} ] + 1 , & w / prob . \{ {n}_{e} \}\end{matrix} \qquad ( 15 )$$

where nₑ is the learnable exponent bitlength.

The above approach faithfully represents the relationship between exponent bitlength and the range in an inexpensive way. Its overhead is limited to the single bitlength parameter and a random number (in the forward pass) per value group sharing a datatype (e.g., tensor), and a single operation (in the backward pass) per value. In some cases, in order to obtain the fully quantized value, the input can be bound with R to remove the exponent bits and then P can be applied to remove the mantissa bits.

Advantageously, the above approaches can be applied to each activation and weight tensor separately. Since the minimum bitlength is 0, nₘ and nₑ can be clipped at 0. This extension of the bitlengths in the continuous domain allows the loss to be differentiable with respect to both Exponent and Mantissa bitlengths. In some cases, the above approaches can be applied during the forward pass. Quantized values can be saved and used in the backward pass. This strategy reduces the footprint of training because only quantized values are used in forward and backward passes.

In some cases, the loss L can be used to penalize Mantissa and Exponent bitlengths by adding a weighted average of their volume:

$$L = {L}_{l} + {γ}_{m} \times \sum i ( {λ}_{i} \times {n}_{m}^{i} ) + {γ}_{e} \times \sum i ( {λ}_{i} \times {n}_{e}^{i} ) \qquad ( 16 )$$

where Lₗ is the original loss, γₘ and γₑ are regularization coefficients determining quantization aggressiveness, λᵢ is the importance of the i^{th} group of values (any suitable granularity can be used, for example one λᵢ per tensor), and

$${n}_{m}^{i}$$

and

$${n}_{e}^{i}$$

are the mantissa and exponent bitlengths of the activations or weights in that tensor. In other cases, instead of using a weighted average of the volume, a weighted sum based on number of operations on each tensor can be used, or use a weighted sum of squares.

The augmented loss adds a competing objective for training. Overemphasizing bitlength choice may sacrifice task performance, while underemphasizing it may sacrifice potential gains. Balancing the objectives via γ selection is advantageous for at least two reasons. First, selecting γ such that the bitlength loss component is 1-2 orders of magnitude smaller than the main task objective loss is enough to squeeze out most of the reduced datatype benefits whilst being sufficiently small to not adversely influence final accuracy. Second, finding the best γ is not necessary because learning the bitlengths is a very coarse task, and at the end, the bitlengths have to be rounded to appropriate integers. For the example experiments, setting both γₘ and γₑ to 0.1 proved sufficient. Adapting both γₘ and γₑ during the training process may also be advantageous.

The loss function can be used to target any quantifiable criteria by a suitable selection of λᵢ's. Since the general goal is to minimize the total footprint of training, each tensor can be weighed according to its memory footprint.

The above approaches for Quantum Mantissa and Quantum Exponent add minimal computational and memory overheads. In the forward pass, random numbers are needed at a chosen granularity as per Equations (6) and (16). The example experiments show that a random number per tensor per batch is generally sufficient and is of a negligible cost. To update the bitlength parameters in the backward pass, their gradients are determined. These are a function of the quantized values and gradients, which are determined during the regular backward pass. The extra calculations are proportional to the number of values. This overhead is negligible in comparison to the total number of computations. For instance, for ResNet18 the overhead is less than 1%. In most cases, the only new parameters that are stored are the four floats per layer (mantissa and exponent bitlength for weights and activations), which are negligible in comparison with the total footprint; whereby the other values are consumed as they are produced.

Generally, non-integer bitlengths are used. In some cases, integer bitlengths can be used by disabling learning bitlengths when they are not needed, at which point the bitlengths are rounded up and frozen. The example experiments show that bitlengths converge quickly to the final bitlengths within a couple of epochs. Accordingly, the bitlengths can be frozen after a given number of epochs (for example, 5 epochs). This avoids the small overhead for most of the training. In some cases, where both Quantum Mantissa and Quantum Exponent are used concurrently, some tensors might need more bits later in training. Accordingly, Quantum Mantissa and Quantum Exponent can be re-enabled for an additional number of epochs (for example, 5 epochs) on every learning rate change. This allows precision to increase where necessary to accommodate the reduction in update magnitudes. Regardless of whether Quantum Mantissa and Quantum Exponent are enabled or disabled, the benefits of reduced bitlengths apply throughout training, and thus, such enablement and disablement are not strictly necessary. Example experiments where the bitlengths were fixed after 5 epochs still converged and achieved marginally lower accuracy. While the example experiments show that bitlengths converge quickly and final bitlengths can be determined within a couple of epochs, by avoiding the small overhead for most of the training, this action can be avoided so that bitlengths have the ability to increase if needed during training. The example experiments show that this is unnecessary for the models studied; however, the overhead is so small that it can be left on as a safety mechanism. In some cases, the bitlengths can be rounded up for the last number of epochs (for example, 10 epochs) to let the network regain any accuracy that might have been lost due to Quantum Mantissa. In any case, the network can still be compressed during this time.

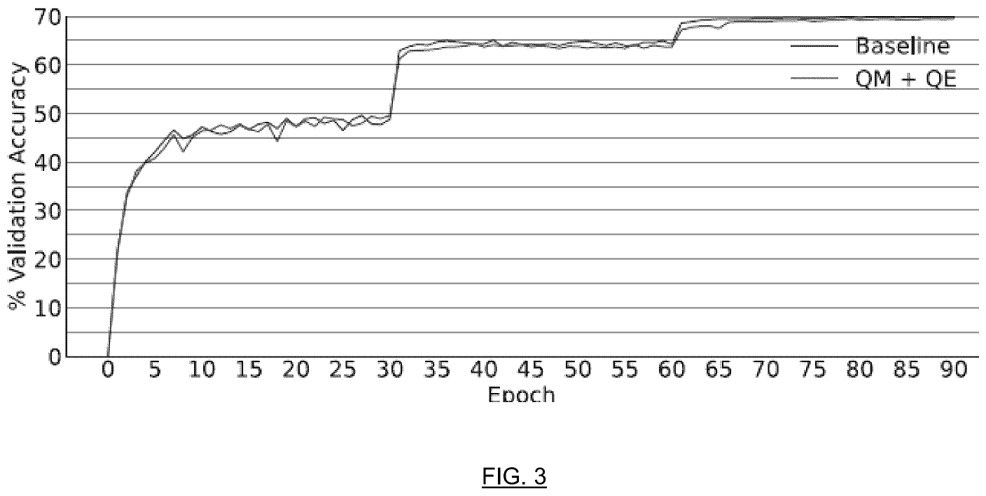

The example experiments report measurements for per-layer weights and activations quantized separately using a loss function weighted to minimize overall memory footprint. In the experiments, a ResNet18 model is trained on the ImageNet dataset over 90 epochs, with regularizer strength of 0.1, learning rate of 0.1, 0.01 and 0.001 respectively at epochs 0, 30, and 60 and weight decay of 0.0001. Both Quantum Mantissa and Quantum Exponent were shown to excel at minimizing the memory footprint whilst not introducing accuracy loss. FIG. 3 shows that throughout training, the present embodiments introduce minimal changes in validation accuracy converging to a solution within 0.4% of the FP32 baseline. Minor accuracy loss occurs when actively pushing bitlengths to their limits. Any loss is quickly regained when bitlenghts are frozen and rounded up since this relaxes the value range.

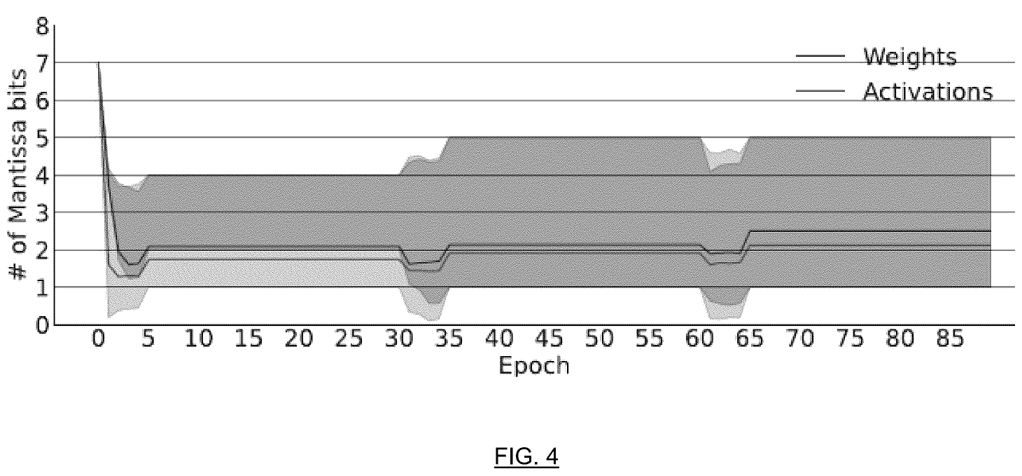

FIG. 4 shows how Quantum Mantissa quickly (within a couple of epochs) reduces mantissas below 2 b on average. The large spread in bitlengths across layers shows that it is a granular, per tensor approach that boosts benefits. In comparison, FP8 would use 2-3 b (out of 8) everywhere. While more than 3 b is sometimes allocated for some tensors, this slack boosts overall footprint reduction since it enables shorter bitlengths for larger tensors. Finally, the results show a minor increase of bitlengths across period boundaries of our bitlength learning schedule. The total training cumulative mantissa footprint is reduced to 8.4% of the FP32 mantissa footprint (8.3% for activations and 9.8% for weights).

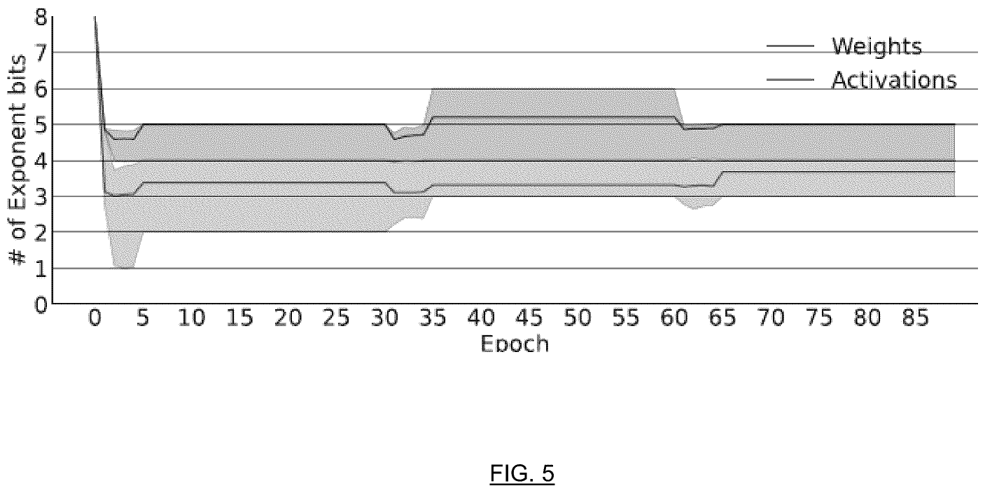

FIG. 5 shows that learning exponent bitlengths with Quantum Exponent exhibits similar behavior. Bitlengths quickly converge to 4 b or less for activations, and on average down to around 5 b for weights. In comparison, FP8 would use 4-5 b (out of 8) everywhere, a fair choice for network-wide bitlength. Longer exponents are sometimes used for some tensors enabling short exponents for large tensors. As a result, Quantum Exponent outperforms FP8 in exponent footprint. Compared to mantissas, the spread in exponent bitlengths across layers is lower yet significant while there is a more noticeable increase of bitlengths from one learning period to the next. The cumulative training memory footprint is reduced to 43.1% of the FP32 exponent footprint (42.7% for activations and 62.8% for weights).

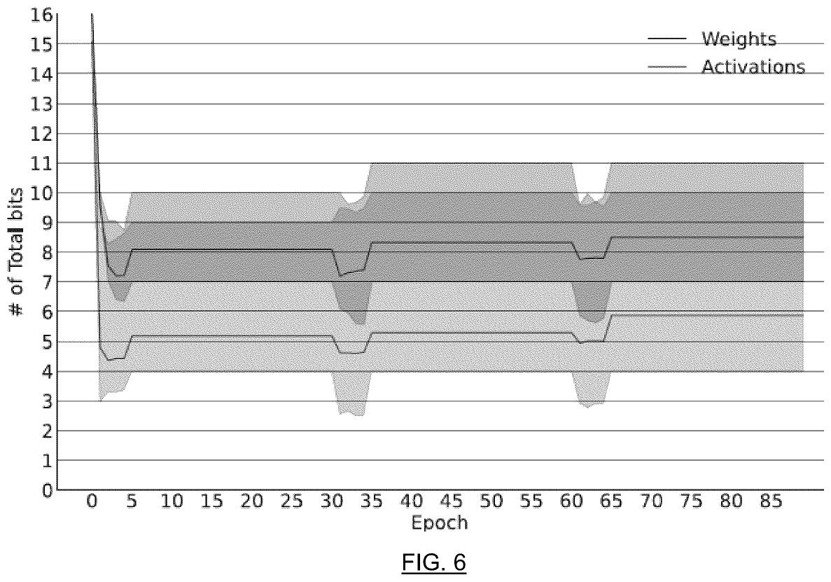

FIG. 6 shows the total bitlength of the datatype for each tensor, including sign, mantissa, and exponent. It further amplifies the advantages highlighted above. Massive footprint reduction, significantly varying bitlength tensor to tensor justifying the fine-grained approach, and slightly increasing bitlength for some tensors learning period to period. To further emphasize the importance of the fine-grained approach, the average and worst-case bitlengths were examined. For instance, the worst-case activation tensor requires 11 b while the average is less than 6 b.

The variability of total, exponent and mantissa bitlengths for weights and activations at the beginning of every epoch is shown in FIGS. 3 to 6. While there are some tensors that share bitlengths, for instance, weight exponents, most bitlengths vary wildly. Generally, choosing datatypes is hard and complicated. If one wants to squeeze as much of a reduction of footprint as possible, they need an automated approach, as presently provided. It is impossible to guess the bitlengths in advance. Cumulatively, on average, the total datatype footprint is reduced by 3.86× (8.28 bits), 5.92× (5.40 bits) and 5.86× (5.46 bits) vs FP32 for weights, activations, and total footprint. Similarly, footprint reduction in comparison with BF16 is 1.93×, 2.96×, and 2.93× for weights, activations, and total, respectively. Finally, the datatype used in a combination of Quantum Mantissa and Quantum Exponent is 32% smaller than FP8.

Quantum Mantissa and Quantum Exponent quickly learns bitlengths that can be used to learn the per tensor datatypes to use for training the network; e.g., if the system 100 needs to retrain the network, it can use bitlengths from the previous iteration as-is. The accuracy of such an iteration increased 0.2% of previous training with Quantum Mantissa and Quantum Exponent. Similarly, bitlengths learned in the first 5 epochs can be used with a small accuracy drop (0.7%). This capability is particularly useful given that there is generally a wide selection of energy-efficient datatypes. This approach can aid or completely replace a manual, trial-and-error selection process, allowing users to automatically benefit from the datatypes from the datatypes their hardware provides.

Quantum Exponent adds minimal computational and memory overhead to the forward and backward passes. In the forward pass, random numbers need to be created at a chosen granularity to determine the quantized values. In some cases, this can be done per value; however, the example experiments show that per tensor/layer is sufficient and is at a negligible cost. To update the bitlength parameters in the backward pass, their gradients need to be determined. These are a function of the weight values and gradients, which are calculated as part of a regular backward pass. As a result, the extra calculations for each bitlength is on the order of O(n), where n is the number of values quantized to that bitlength. Thus, the additional overhead is negligible in comparison to the total number of computations. On the memory side, the only extra parameters that need to be saved are the bitlengths; i.e., two floats per layer for weights and activations. Again, this additional memory is negligible in comparison with the total memory footprint. All other values are generally consumed as they are produced without the need for off-chip stashing.

Quantum Exponent provides a stochastic training approach to find the optimal bitlengths for the floating point exponents. Parameterized Activation Functions with key features are used that make it more efficient and allows this approach to better target expensive off-chip transfers during training. Quantum Exponent can involve operations for both the forward and backward passes of training. Generally, limiting the exponent range affects the real range of numbers represented by the floating point number. From there, the allowable range limits can be parameterized and a straight-through estimator can be used to define the gradient. A quantization scheme can be defined for integer exponent bitlengths in the forward pass, with the exponent bit length directly connected to the limit of the real range of floating-point values; which can be expanded to the non-integer domain. Advantageously, this allows bitlengths to be learned using gradient descent. In some cases, a parameterizable Loss Function can be used that enables Quantum Exponent to penalize larger bitlengths.

To learn the exponents, the system 100 defines the range parametrization with the following function:

$$F ( V , {V}_{max} , {V}_{min} ) = ( \begin{matrix}- {V}_{max} , & V < - {V}_{max} \\ V , & - {V}_{max} \leq V \leq - {V}_{min} \\ 0 , & - {V}_{min} < V < {V}_{min} \\ V , & {V}_{min} \leq V \leq {V}_{max} \\ {V}_{max} , & {V}_{max} < V\end{matrix} \qquad ( 17 )$$

where Vₘₐₓ and Vₘᵢₙ are boundaries.

Partial derivatives of this function with respect to Vₘₐₓ and Vₘᵢₙ are defined as:

$$\frac{\partial F}{\partial {V}_{max}} = ( \begin{matrix}- 1 , & V < - {V}_{max} \\ 0 , & - {V}_{max} \leq V \leq {V}_{max} \\ 1 , & - {V}_{min} < V < {V}_{min}\end{matrix} \qquad ( 18 )$$

$$\frac{\partial F}{\partial {V}_{min}} = ( \begin{matrix}- 1 , & V < - {V}_{min} \\ 0 , & - {V}_{min} \leq V \leq 0 \\ 1 , & 0 \leq V \leq {V}_{min} \\ 0 , & {V}_{min} < V\end{matrix} \qquad ( 19 )$$

In order to calculate the gradient for Vₘₐₓ and Vₘᵢₙ, the gradients in the layer are summed.

Generally, to learn exponent bitlengths there is the challenge that they represent discrete values over which there is no obvious differentiation. To overcome this challenge, a mapping for integer exponent bitlength can be used, and then tree approaches can be used to expand it to a continuous domain. An integer quantization of the exponent E with n bits can be used by defining range and directly mapping it to to Vₘₐₓ and Vₘin:

$${V}_{max} = ( 1 + {M}_{max} ) \times {2}^{{E}_{max}} \qquad ( 20 )$$

$${V}_{min} = {2}^{{E}_{min}} \qquad ( 21 )$$

Where Mₘₐₓ is the largest possible mantissa, Eₘₐₓ is the largest possible exponent, and Eₘᵢₙ is the smallest possible exponent. Eₘₐₓ can be represented as:

$${E}_{max} = {E}_{min} + {2}^{n} - 1 \qquad ( 22 )$$

where n is the learnable exponent bitlength. Similarly, Eₘᵢₙ is the exponent bias of the exponent that can be learned as well.

Any suitable approach can be used to expand the exponent integer bitlength to the continuous domain. In a first example, stochastic exponent bitlength can be used to expand the exponent integer bitlength to the continuous domain. The benefit of this approach is that both the mantissa and the exponent of the threshold value are the maximum of the allowable range. The non-integer exponent length n can be mapped to an integer. In this case, the exponent will be represented by n+1, but the mantissa will always remain Mₘₐₓ. The exponents are then calculated as:

$${E}_{min} = ( \begin{matrix}{E}_{min} , & with probability 1 - \{ {E}_{min} \} \\ {E}_{min} + 1 , & with probability \{ {E}_{min} \}\end{matrix} \qquad ( 23 )$$

$${E}_{max} = ( \begin{matrix}{E}_{min} + {2}^{n} - 1 , & with probability 1 - \{ n \} \\ {E}_{min} + {2}^{n + 1} - 1 , & with probability \{ n \}\end{matrix} \qquad ( 24 )$$

In another example, the exponent bitlengths are learned. This approach can be applied to activations and weights separately. Since the minimum bitlength per value is 0, n is clipped at 0. This presents a reasonable extension of the meaning of bitlength in continuous space and allows for the loss to be differentiable with respect to bitlength. During the forward pass, the above formulae are applied to both activations and weights. The quantized values are saved and used in the backward pass. During the backward pass, a straight-through estimator is used to prevent propagating zero gradients that result from the discontinuity's discreteness; however, the quantized exponents for all calculations can be used. This efficient quantization during the forward pass reduces the footprint of the whole process.

In addition to finding the optimal weights, the modified Loss Function penalizes exponent bitlengths by adding a weighted average (with weights λᵢ, not be confused with the model's weights) of the bits mᵢ required for exponents of weights and activations. Total loss L is defined as:

$$L = {L}_{l} + γ \sum ( {λ}_{i} \times {n}_{i} ) \qquad ( 25 )$$

where Lₗ is the original Loss Function, γ is the regularization coefficient for selecting how aggressive the quantization should be, λᵢ is the weight corresponding to the importance of the i^{th} group of values (one per tensor), and nᵢ is the bitlength of the activations or weights in that tensor. This Loss Function can be used to target any quantifiable criteria by a suitable selection of the λᵢ parameters. Since a particular goal is to minimize the total footprint of a training run, each layer's tensors can be weighed according to their footprint.

Quantum Exponent adds minimal computational and memory overhead to the forward and backward passes. In the forward pass, random numbers need to be created at a chosen granularity to determine the quantized values. Generally, this would be done per value; however, example experiments show that per tensor/layer is sufficient and is a negligible cost.

To update the bitlength parameters in the backward pass, their gradients need to be determined. These are a function of the weight values and gradients, which will be calculated as part of regular backward pass. As a result, the extra calculations for each bitlength is on the order of O(n), where n is the number of values quantized to that bitlength. This overhead is negligible in comparison to the total number of computations. On the memory side, generally, the only extra parameters that need to be saved are the bitlengths; two floats per layer (for weights and activations), which are again negligible in comparison with the total footprint. Other values are generally consumed as they are produced without the need for off-chip stashing.

A training approach using Quantum Mantissa and Quantum Exponent will produce non-integer exponent bitlengths and generally requires stochastic inference (given a fractional bitlength, the surrounding integer bitlengths can be selected at random per tensor). In some cases, it may be preferable to not have this requirement when deployed. For this reason, the exponent bitlengths can be rounded and fixed for some training time to fine-tune the network to this state. While the example experiments show that bitlengths converge quickly and final ones can be determined within a couple of epochs (which avoids the small overhead for most of the training), this action can be delayed so that bitlengths have the ability to increase if needed during training. The example experiments show that this may be unnecessary for the models studied; however, the overhead is so small that it can be left on as a safety mechanism. The bitlengths can be round up for, for example, the last 10 epochs to let the network regain any accuracy that might have been lost due to Quantum Exponent, which still reduces traffic during these epochs.

Embodiments of the present disclosure further provide an approach that monitors training progress and adjusts the mantissa bitlength and exponent ranges accordingly, as long as the network is improving. This approach is informally referred to as ‘BitWave’. Advantageously, this approach does not interject into the training implementation and does not have any overhead. BitWave will attempt to use a shorter mantissa (referred to as ‘BWM’) and to reduce the available exponent value range (referred to as ‘BWE’). BitWave is particularly useful where past observations of training progress are good indicators of forthcoming behavior. In most cases, training is a long process based on trial-and-error, which is generally forgiving for momentary lapses in judgement.

BitWave generally aims to strike a balance between reducing bitlengths while avoiding over-clipping and potentially hurting the learning progress. In this way, in most cases, BitWave can: use a slope of a simple linear regression over a history of the loss as a proxy for network progress; observe training progress and adjust bitlengths every batch; and/or use the same bitlengths for the entire network.

While the loss generally improves over time, when observed at every batch it exhibits non-monotonic (sometimes erratic) behavior. BitWave compensates for this by calculating a least squares regression (minimization of total sum of squared differences between predicted regression and history values) over a history of previous loss values. BitWave then uses the slope of the linear regression at each batch to smooth the non-monotonic behavior.

The BitWave approach adjusts the mantissa length (unchanged, lower, or higher) by observing the slope of the linear regression within a threshold T. A negative slope indicates learning is improving, allowing for further mantissa trimming. A positive slope indicates no learning progress and responds by increasing mantissa bitlength. If the slope is within a small threshold T of 0.0, then the system 100 keeps observing and does not alter the bitlength.

In an example, considering the range of FP32 exponents ([−126,127]), the BitWave approach adapts the range of values symmetrically by adjusting both limits. Exponents below the minimum can be clamped to 0, whereas those above the maximum value saturate at that. This gradual change eventually reduces or increases the exponent bitlength. BitWave adjusts the exponent range (unchanged, lower, or higher) by examining the slope of the calculated linear regression. A negative slope (within a threshold T) is assumed to indicate improvement, allowing the range to shrink. A positive slope (within the same threshold T), indicates deteriorating learning, in which case the exponent range is widened.

Similarly to Quantum Mantissa and Quantum Exponent, the BitWave approach can produce non-deterministic datatypes due to its intrinsic fluctuations throughout training because of its heuristic nature. To avoid this non-determinism and provide usable bitlengths for inference, the BitWave approach can fix the mantissa bitlength and the exponent range after a few epochs of training, by calculating the average of all the bitlengths up to that point of training, as well as the average of the exponent range. The BitWave approach can then uses these averages for the rest of training. Experiments on the convergence of BitWave show that the networks converge to the same accuracies (±0.1%) whether the bitlengths are fixed or not, and there are evident benefits of creating deterministic inference-capable bitlengths.

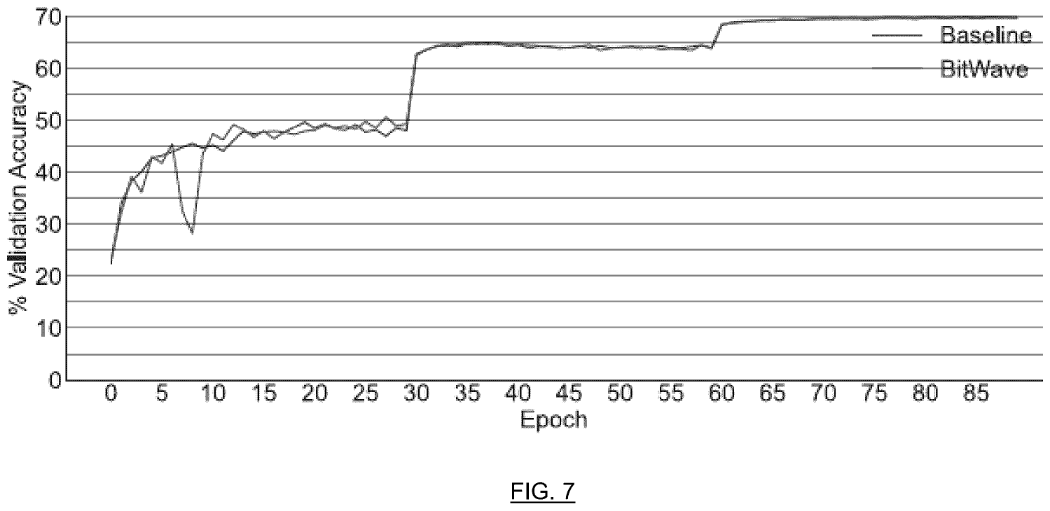

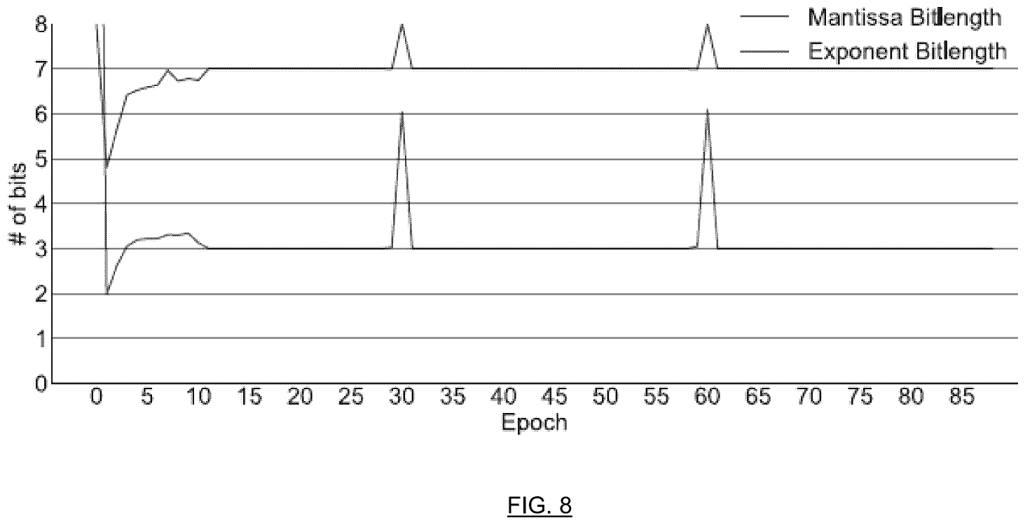

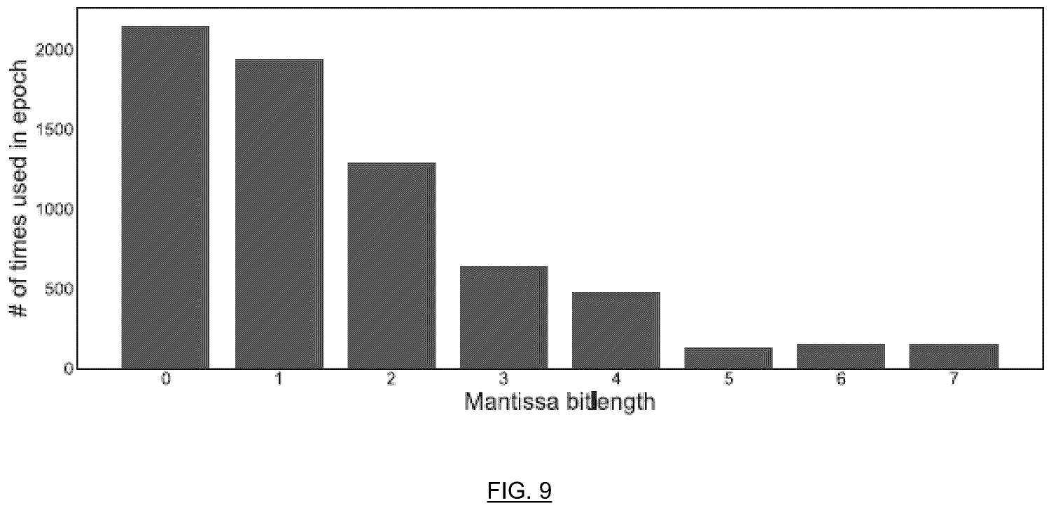

The example experiments investigated the BitWave approach's effect on footprint and accuracy during full training sessions of ResNet18. FIG. 7 shows that validation accuracy is unaffected. FIG. 8 shows that the BitWave approach reduces mantissa bitlengths to 3 b on average from baseline precision. However, mantissa bitlengths may vary slightly per batch as illustrated in the histogram (FIG. 9) of bitlengths used throughout a sample epoch. This shows that training sometimes requires the entire range whereas other times it only requires 0 bits. Across the training process, the BitWave approach reduces the total mantissa footprint to 14.3% of baseline, and the total exponent footprint to 83.8%. While the BitWave approach might miss bitlength reductions per layer and might not reduce the exponent bitlength as much by itself, it advantageously is non-intrusive and has no overhead.

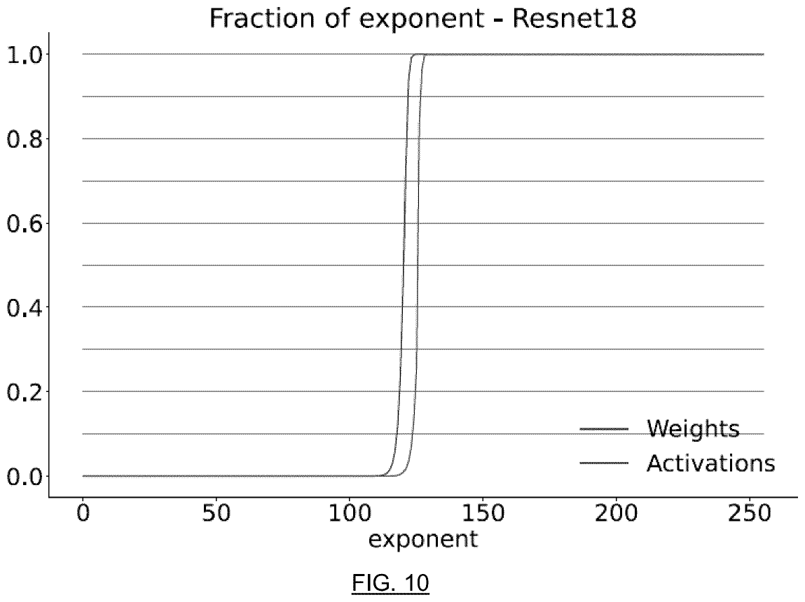

The exponents are biased integers of 8 b for BF16 or FP32 and much fewer bits for Quantum Exponent and BitWave Exponent. During training, exponent values exhibit a heavily biased distribution and are often centered just below value 0. FIG. 10 shows the exponent distribution throughout training of ResNet18 after epoch 10. Taking advantage of the small magnitude of most exponents, a variable length lossless encoding can be used that uses only as many bits as necessary to represent the specific exponent value (e.g., uses 2 b to store the value 3 instead of 8 b). Prior to detecting how many bits are needed, the exponent is converted to an inverted 2's complement, so that zero and small integers map to zero and small positive values, while the large integers represent the positive values. In this way, there is no need to store the sign bit at the expense of using more bits for the much less frequent positive values. Due to the variable-sized exponents, a 3 b metadata field can be used to specify the number of bits used. To amortize this cost, multiple exponents can share a common bitlength. It can be observed that the values exhibit spatial correlation (values that are close by have similar magnitude). Encoding differences in value skews the distribution closer to zero, benefiting the approach of the present embodiments.

In a particular encoding scheme, informally referred to as ‘Gecko’, given a tensor, the values are grouped into groups of 64 (padding as needed); which is treated as an 8×8 matrix. Every column of 8 exponents is a group that shares a common exponent length. A leading 1 detector determines how many bits are needed for each column. The bitlength is stored using 3 b and the exponents are stored using the bitlength chosen. Encoding values with variable bitlengths makes random accesses challenging as it is no longer possible to directly compute the address where tensor values are stored using their index. However, deep learning workloads generally do not need to perform such random accesses to DRAM; blocking for data reuse translates to long sequential accesses to DRAM. These facilitate the use of variable length containers. In an alternate implementation, a suitable bias is removed from every exponent and a row of 8 exponents is stored using a bitlength suitable for storing all exponents in the group. The bitlength is determined by the maximum magnitude of the exponents after subtracting the bias. The advantage of this approach is that it operates on a single group and that it does not require delta encoding.

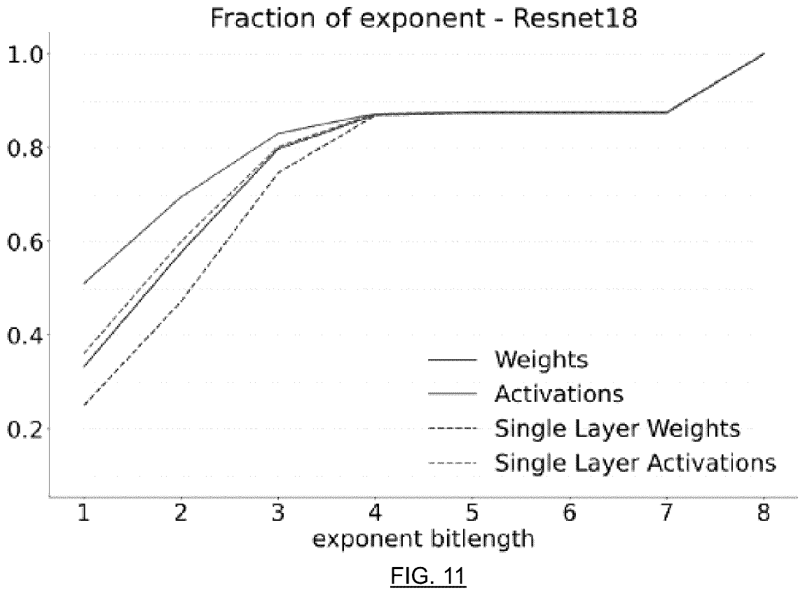

The system 100 measures the number of bits needed to encode the exponents using Gecko during training. FIG. 11 illustrates the cumulative distributions of exponent bitlength for one batch across all layers and for a single layer, separately for weights and activations. After delta encoding, almost 90% of the exponents are lower than 16, and 20% of the weight exponents and 40% of the activation exponents need only 1 bit. Across training, the overall compression ratio is 0.56 and 0.52 for weight and activation exponents respectively.

The example experiments evaluated the effects of Quantum Mantissa and Quantum Exponent, and BWM and BWE, with and without Gecko. The example experiments fully trained ResNet18 and ResNet50 on ImageNet, DLRM on Kaggle Criteo as well as pre-train ViT on Cifar10, finetune BERT on GLUE and GPT-2 on Wikitext 2. Quantum Mantissa and Quantum Exponent were implemented by modifying the loss function and adding the gradient calculations for the per tensor parameters. BWM and BWE were simulated in software. For both approaches, all bitlength arithmetic effects were emulated by truncating the mantissa bits and encode/decode exponents at the boundary of each layer using PyTorch hooks and custom layers. The effects of Gecko were determined in software via hooks. These changes allow the measurement of the effects on traffic and accuracy.

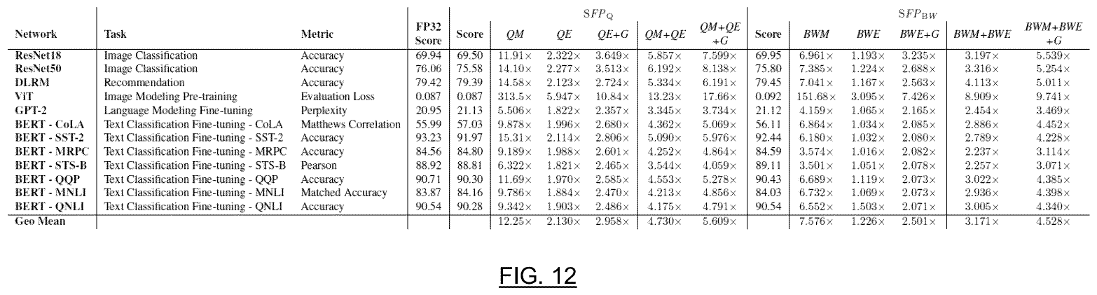

The cumulative memory footprint reduction and validation accuracy in comparison with FP32 is shown in FIG. 12. The compression techniques of the present embodiments excel at reducing footprint, with little effect on accuracy. Quantum Mantissa and Quantum Exponent reduce the total training footprint by 3.35×-13.24× with an average of 4.73×. While Quantum Mantissa and Quantum Exponent also perform well on exponents, it is exceptionally good at compressing mantissas. With the addition of Gecko, the benefits further extend to 3.73×-17.66× with an average of 5.61×. BWM and BWE on the other hand reduce the total training footprint by 2.24×-8.91× with an average of 3.17× without, and 3.07×-9.74× with an average of 4.53× with Gecko, respectively. While BWM and BWE provide a great compression rate for mantissas, it is less effective for exponents. The addition of Gecko recovers most of the compression gap. Ultimately, Quantum Mantissa and Quantum Exponent outperforms BWM and BWE for every case, with only a slightly larger overhead.

Gecko boosts the compression rate by 19% and 43% on top of Quantum Mantissa and Quantum Exponent, and BWM and BWE, respectively. It generally performs better for BWM and BWE because it greatly removes outliers, and helps it recover almost all of the exponent compression gap. This comes at the cost of variable tensor sizes, and therefore inability of random memory accesses to the off-chip memory. Fortunately, training generally only requires sequential access to off-chip memory, and sequential/strided/random accesses to on-chip memory which are fully supported.

Alternative quantization approaches require selecting a datatype for training and generally proceeding with it. The choice is generally between FP32, Bfloat16, and FP8. FIG. 12 shows memory reduction in comparison with FP32. Assuming that the network converges with the smaller datatype, Bfloat16 would always reduce the footprint by 2× and FP8 by 4×. Every single combination of the present embodiments outperforms FP32 and BFloat16 by a significant margin. Furthermore, FP8 produces a 18% larger footprint than Quantum Mantissa and Quantum Exponent with GPT2 being the only network where FP8 wins. When Gecko is added, FP8s overhead increases to 40%.

Advantageously, the approaches of the present embodiments are adaptable. Choosing FP8 is generally risky because the results of training are only evident at the end. In contrast, the present embodiments provide a greater certainty of success, whilst obtaining a better footprint.

For some models, fixed-point training is possible. While generally the system 100 learns the optimal floating-point datatypes, Quantum Mantissa can be adapted to learn optimal fixed-point datatypes. For example, to train for fixed-point inference, the activations can be represented in fixed point during training and integer arithmetic can be used during the forward pass. The sole modification required is switching out Equation 5 for one that represents fixed-point. For ResNet18, the example experiments indicated that the accuracy was 69.15 (compared to 69.94 for FP32) with a 6.21× footprint reduction. The modified Quantum Mantissa learns the per-tensor optimal bitlengths for uniform quantization training with minimal accuracy cost. This also represents a good choice for training when there is confidence that the task the network is solving can be done in low bitlength fixed-point.

Quantum Mantissa and Quantum Exponent determine the minimal mantissa and exponent bitlengths on, for example, a per-layer granularity for training and inference of neural networks. In some cases, hardware/software stacks may be unable to support arbitrary bitlengths. DataType Select (DS) is a particular implementation of Quantum Mantissa and Quantum Exponent that allows for a selection from a predetermined list of available datatypes.

The training of a neural network with DataType Select can consist of two phases: a Learning Phase and a Fixed Phase. In the Learning Phase, both Quantum Mantissa and Quantum Exponent can be used to determine the minimal bitlength of the mantissa and exponent on a per tensor granularity (coarser and finer granularities are possible if desired). The smallest (most desirable) datatype that supports the larger of the bitlengths is used in each tensor. The unused bits can be masked to zero. In the Fixed Phase, Quantum Mantissa and Quantum Exponent are disabled and all bitlengths are rounded up. For each tensor, the smallest (most desired) datatype is selected. The full range of the selected datatype can be used without modification throughout the Fixed Phase.

In the example experiments, ResNet18 was trained on ImageNet with the default hyper-parameters. The Learning Phase lasted for 15 epochs while the Fixed Phase lasted for the remaining 75. The γ parameter for Quantum Mantissa and Quantum Exponent was set to 0.1. The following datatypes were defined as available (in the order of descending desirability): FP8 (M3E4), FP8 (M2E5), BF16 (M7E8), FP16 (M10E5) and FP32 (M23E8). DataType Select converged within a couple of epochs to the final datatypes. The majority of the selected datatypes were one of the two varieties of FP8. The first and last layers required BF16 for both activations and weights. In addition, one of the weight tensors towards the middle of the network required BF16 as well. All of the BF16 selected tensors are very close to the FP8/BF16 boundary. A stronger regularizer would likely select only FP8 datatypes (of both varieties) throughout the network. However, that may lead to a slightly larger accuracy drop. The differences in accuracy compared to the FP32 baseline were very small. The final validation accuracies after training for DataType Select was 69.72, for Quantum Mantissa and Quantum Exponent was 69.37, and for the baseline was 69.78. The differences were thus minimal. DataType Select matches baseline accuracy and slightly outperforms Quantum Mantissa and Quantum Exponent alone. It should be noted that DataType Select can also work for fixed point (integer) training where for each tensor, the Learning Phase would learn the optimal bitlength, while the Fixed Phase would select the minimal available bitlength that is larger or equal to the learned one.

In another approach, which is more intrusive, datatype selection can be built directly into Quantum Mantissa and Quantum Exponent. In this case, the stochastic/deterministic interpolation between nearest bitlengths is changed to stochastic/deterministic interpolation between the nearest available datatypes in the Learning Phase. The Fixed Phase remains the same.

Similar to Quantum Mantissa and Quantum Exponent, another approach, informally referred to as ‘BitWave’, determines the minimal mantissa and exponent bitlengths for training and inference of neural networks, but with a single bitlength on a network level. BitWave treats the training process as a black box, from which it interprets its current progress via heuristics. If the network is training correctly, BitWave reduces the number of bits allowed to both exponents and mantissas. If the bitlength reduction has taken an impact on the network's training progress, BitWave increases the number of bits allowed.

When a predetermined list of available datatypes is given to BitWave, BitWave continuously adapts the allowed bitlength, zeroing the bits that are not allowed to the network on each value. Similarly to the more intrusive approach of DataType Select, BitWave will choose, at each moment, the datatype that should be used from the list of available datatypes. It will at any point select the datatype that completely fits the current allowed bitlength. BitWave will push the network towards reducing bitlengths to fit in the lower bitlength datatypes of the available list.

The quantization schemes of the present embodiments can be implemented, in a particular case, with hardware encoder/decoder units. Without the loss of generality, compressors/decompressors are described that process groups of 64 FP32 values. The hardware compressors/decompressors transparently encode/decode tensor values before the controller for the memory storage. When values are stored to external DRAM, the encoders efficiently encoded the values to use as few bits as necessary. When values are read back from external DRAM, the decoders expand the values to the original format. In this way, the rest of the on-chip memory hierarchy and compute units can remain as-is.

The encoders trim each value as provided herein. For the mantissa, the encoders discard as many least significant bits as instructed by either Quantum Mantissa or BitWave. The number of mantissa bits discarded is the same across a whole tensor. As a result, a single metadata field stored along with the layer metadata is sufficient. For a mantissa of up to 23 bits, a 5 bit metadata is sufficient. For the exponent, the encoder determines what is the minimum number of bits needed to encode the magnitude (after removing the bias). Since the number of bits used for the encoded exponent will vary, a metadata field may be needed to recall how many bits were used. To reduce this metadata overhead, the encoders can select the exponent container bitlength across a group of exponents.

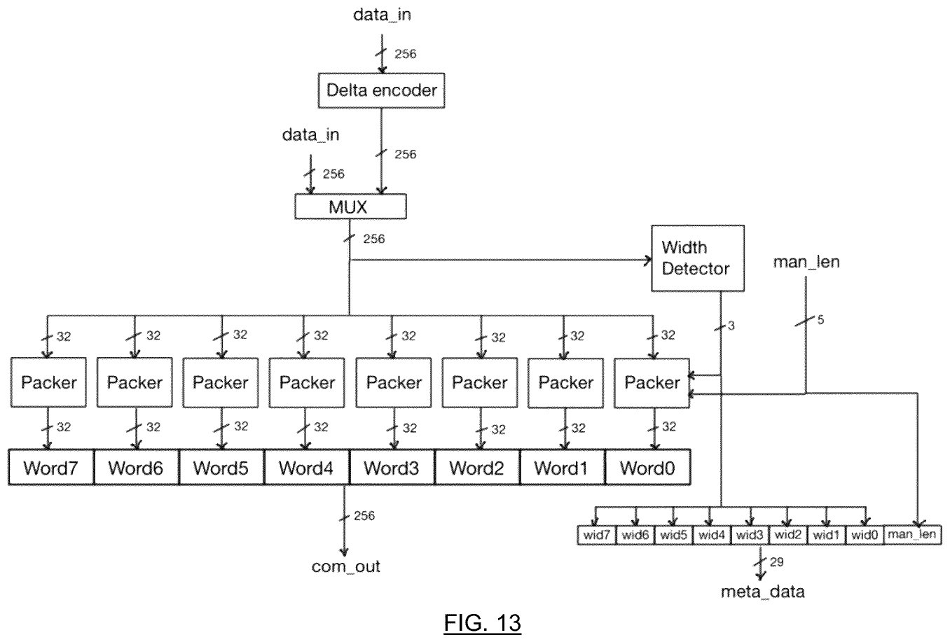

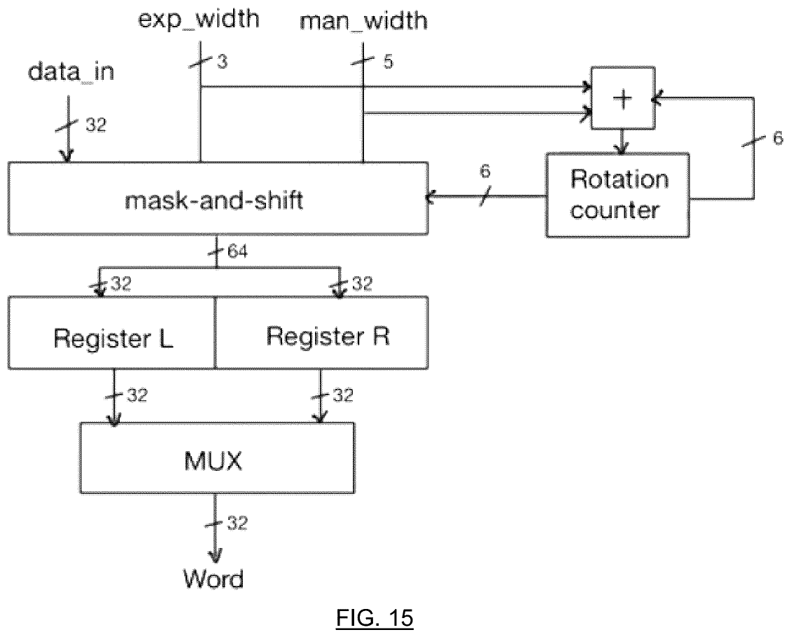

FIG. 13 shows an example of the compressor that contains 8 packer units (illustrated in FIG. 15). The compressor accepts one row (8 numbers) per cycle, for a total of 8 cycles to consume the whole group. Each column is treated as a subgroup whose exponents are to be encoded using the first element's exponent as the base and the rest as deltas. Accordingly, the exponents of the first row are stored as-is via the packers. For every subsequent row, the compressor first calculates deltas prior to passing them to the packers.

In this implementation, the length of the mantissa is the same for all values and is provided by the mantissa quantizer from Quantum Mantissa or BitWave. Each row uses a container whose bitlength is the sum of the mantissa bitlength (provided externally) plus the bitlength needed to store the highest exponent magnitude cross the row. To avoid wide crossbars when packing/unpacking, values remain within the confines of their original format bit positions. Advantageously, every row uses a different bitlength, the values are floating-point, the bitlengths vary during runtime and per row, and it is implemented during training. The exponent lengths can be stored as metadata per row. These can be stored separately, necessitating two write streams per tensor; both, however, are sequential and thus DRAM-friendly. The mantissa lengths are either tensor/layer, or network-wide, and can be stored along with the other metadata for the model. The highest magnitude exponent per group generally dictates the container size used for the whole group. This enables the system to use a single metadata per group; amortizing its cost across multiple exponent values. Since the mantissa bitlength can be the same across the whole tensor, and since the exponent bitlength can be the same across a group of values, all the values within the same group can be encoded with the same number of bits per value. This advantageously allows the decompressor to decode all values within a group in parallel.

As a byproduct of data reuse optimizations, accesses to tensor data in external DRAM uses streams in large sequential blocks. Random accesses to DRAM are needed only at the level of these blocks and not at the level of individual values. This allows the system to tightly pack values using variable bitlength containers. When the values are read back from DRAM, they can be decoded one group at a time. Given that the groups contain several values, the system can meet the high bandwidth demands of the on-chip memory hierarchy and compute units.

The decompressors process the values within a group by expanding them to the original format. For mantissa, they pad each value with additional least significant bits which are all set to zero. For the exponent, the exponent is first zero-extended to the original bitlength and then the bias is added. Multiple compressor and decompressor units can be used to keep up with bandwidth demands. The hardware design allows encoding with variable containers while avoiding the cost of large crossbars.

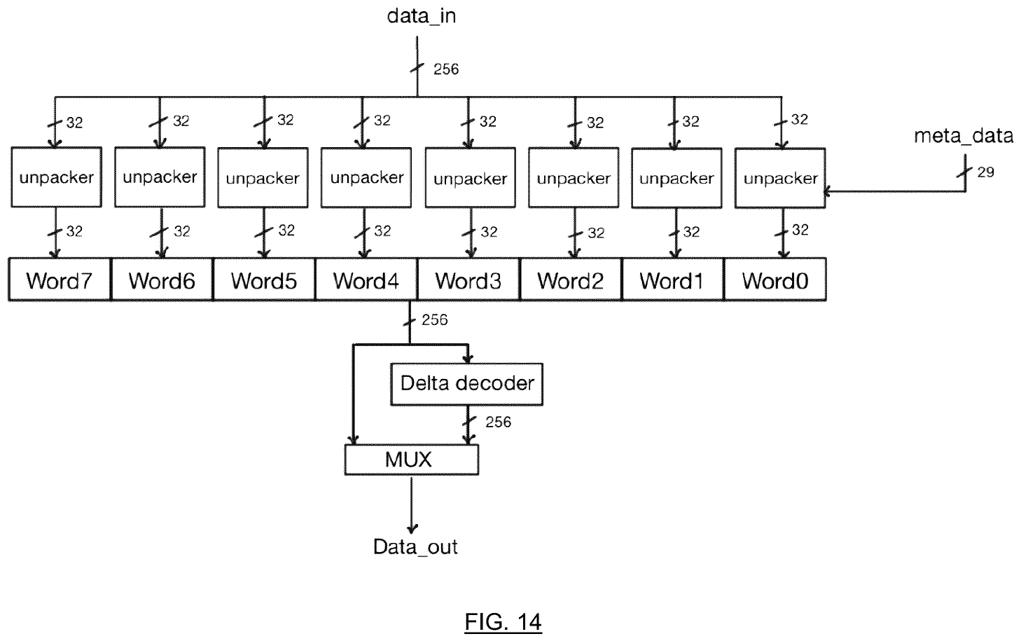

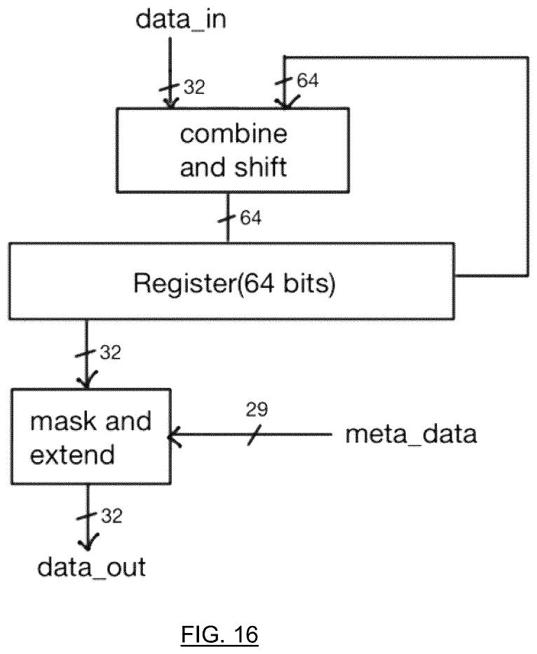

FIG. 13 illustrates an example schematic for a compressor in accordance with an embodiment. FIG. 14 illustrates an example schematic for a decompressor in accordance with an embodiment. FIG. 15 illustrates an example schematic for a packer in accordance with an embodiment. FIG. 16 illustrates an example schematic for an unpacker in accordance with an embodiment. In a particular case, the compressor, decompressor, packer, and unpacker can be implemented as part of the processing unit 160.

Each packer (FIG. 15) takes a single FP32 number in [exponent, sign, mantissa] format, masks out unused exponent and mantissa bits, and rotates the remain bits to position to fill in the output row. The mask is created based on the exp_width and man_width inputs. The rotation counter register provides the rotation count which is updated to (exp_width+man_width+1) every cycle. The (L,R) register pair is used to tightly pack the encoded values into successive rows. These are generally needed since a value may now be split across two memory rows. When either register, its 32 b (or 16 b for BFloat16), are drained to memory. This arrangement effectively packs the values belonging to this column tightly within a column of 32 b in memory. Since each row is the same total bitlength, the 8 packers operate in tandem filling their respective outputs at exactly the same rate. As a result, the compressor produces 8×32 b at a time. The rate at which the outputs are produced depends on the compression rate achieved; the higher the compression, the lower the rate.

As FIG. 14 shows, the decompressor mirrors the compressor. It takes 8 3-bit exponent widths and a mantissa length from the system, and 8×32 bits of data per cycle. Every column of 32 b is fed into a dedicated unpacker per column. The unpacker (FIG. 16) reads the exponent length for this row and the global mantissa length, takes the correct number of bits, and extends the data to [exponent, sign, mantissa] format. Each unpacker handles one column of 32 b from the incoming compressed stream. The combine-and-shift will combine the input data and previous data in register then shift to the left. The number of shifted bits is determined by the exponent and mantissa lengths of this row. The 32-bit data on the left of the register are taken out and shifted to the right (zero extending the exponent). Finally, the unpacker reinserts the mantissa bits that were trimmed during compression. Since each row of data uses the same total bitlength, the unpackers operate in tandem consuming data at the same rate. The net effect is that external memory sees wide accesses on both sides.

To evaluate performance and energy, the example experiments analytically modelled the time and energy used per layer per pass of a baseline accelerator. To do so, traffic and compute counts were collected during the full training runs. These counts were recorded each time a layer was invoked using PyTorch hooks. There were two Gecko compressor/decompressor units per channel.

Due to the complexity and time cost of cycle-accurate hardware simulation, an estimated time and energy consumption analytical model was used. To compute the analytical model, the network was analyzed and its structure was retrieved (layer input and output sizes, kernel sizes for convolutional layers, stride, bias and padding). The compute operations were calculated for the general batch size (N) in both the forward and backward pass, as well as the number of parameters that must be stored in memory for activations, weights and gradients.

To take advantage of data reuse where possible, the forward pass was performed in a layer-first order per batch. This allows the weights to be read per layer only once per batch. For the backward pass, the on-chip buffers were utilized for mini-batching with a layer-first order over a mini-batch of samples. Mini-batching reduces overall traffic by processing as many samples as possible in a layer-first order avoiding either having to spill gradients or reading and writing weights per sample per layer. The number of samples that can fit in a mini-batch depends on the layer dimensions and the size of the on-chip buffer.

Both SFP_{Q} and SFP_{BW} sample bitlengths per batch to a log file for both mantissas and exponents. These bitlengths were used to compute the number of mini-batches that can fit at every training step per layer on chip. Based on the number of sampled mini-batches (K), the memory footprint generated on the forward pass for each method was determined. After this, the footprint was determined that stays on-chip and that can be loaded from on-chip for the backward pass, and the footprint that goes to off-chip and that has to be loaded to on-chip again for it. Based on these memory accesses, DRAMsim was used to simulate the number of compute-cycles that take the memory accesses to finish and the maximum cycles were used between compute and memory as the time constraint to calculate total computation time in the hardware of the present embodiments.

To calculate energy consumption and efficiency, the information gathered in terms of on-chip memory access cycles, off-chip memory access cycles and compute cycles were used. Energy consumption was estimated for all components, including the compressors and decompressors. The following equations were used to estimate energy consumption: where,

$${E}_{forward} = {E}_{compute fwd} + {E}_{offchip in act mem} + {E}_{offchip wgt mem} + {E}_{offchip in act mem} + {E}_{onchip in act mem} + {E}_{onchip wgt mem} + {E}_{onchip out act mem} + {E}_{read ops mem} + {E}_{decomp wgt} + {E}_{comp act} \qquad ( 26 )$$

$${E}_{backward} = {E}_{compute bck} + {E}_{offchip in act mem} + {E}_{offchip wgt mem} + {E}_{onchip in act mem} + {E}_{onchip wgt mem} + {E}_{read ops mem} + {E}_{decomp act} + {E}_{decomp wgt} \qquad ( 27 )$$

$${E}_{offchip in act mem} = \frac{MemCh \times {P}_{DRAM}}{{Freq}_{compute}} \times {Cycles}_{offchip in act} \qquad ( 28 )$$

$${E}_{offchip wgt mem} = \frac{MemCh \times {P}_{DRAM}}{{Freq}_{compute}} \times ( {Cycles}_{offchip wgt} + {Cycles}_{offchip wgt grad} ) \qquad ( 29 )$$

$${E}_{offchip out act mem} = \frac{MemCh \times {P}_{DRAM}}{{Freq}_{compute}} \times {Cycles}_{offchip out act} \qquad ( 30 )$$

$${E}_{onchip in act mem} = {Cycles}_{onchip in act write} \times {P}_{onchip write} \qquad ( 31 )$$

$${E}_{onchip wgt mem} = {Cycles}_{onchip wgt read} \times {P}_{onchip read} \qquad ( 32 )$$

$${E}_{onchip out act mem} = {Cycles}_{onchip out act read} \times {P}_{onchip read} + {Cycles}_{onchip out act write} \times {P}_{onchip write} \qquad ( 33 )$$

$${E}_{decomp} = {P}_{decomp ( comp ratio )} \times \frac{{Cycles}_{comp to decomp}}{{Freq}_{compute}} \qquad ( 34 )$$

$${E}_{comp} = {P}_{comp ( comp ratio )} \times \frac{{Cycles}_{decomp to comp}}{{Freq}_{compute}} \qquad ( 35 )$$

$${E}_{decomp act} = {E}_{decomp act ( comp ratio )} \qquad ( 36 )$$

$${E}_{decomp wgt} = {E}_{decomp wgt ( comp ratio )} \qquad ( 37 )$$

$${E}_{comp act} = {E}_{comp act ( comp ratio )} \qquad ( 38 )$$

Table 1 illustrates the hardware area overhead for the hardware design of the present embodiments:

TABLE 1

| Module | area per unit (μm²) | unit number | total area (mm²) |
|---|---|---|---|
| Compressor | 40682.88 | 16 | 0.651 |
| Decompressor | 46481.40 | 16 | 0.744 |
| Accelerator | 38533.68 | 8000 | 308.27 |

Table 2 illustrates the power consumption as a function compression ratio (P( ) terms) for the hardware design of the present embodiments:

TABLE 2

| Compression ratio | Compressor power (mW) | Decompressor power (mW) |
|---|---|---|
| 0.143-0.263 | 10.87 | 13.84 |
| 0.264-0.388 | 12.18 | 14.72 |
| 0.389-0.513 | 12.65 | 15.97 |
| 0.514-0.638 | 13.44 | 15.76 |
| 0.639-0.763 | 14.98 | 15.42 |

The present embodiments advantageously adapt the bitlengths and containers, dynamically, that are used for floating-point values during training. The different distributions of the exponents and mantissas have tailored approaches for each. In this way, the present embodiments target the largest contributors to off-chip traffic during training for both activations and weights. In addition, in the case where fixed-point training is preferred, a modified version can be used to determine the best containers used for fixed-point values during training. In this way, the present embodiments determine and continuously adjust the memory containers (how many bits should be used when storing floating-point mantissas and exponents in memory), and do so on-the-fly for the purpose of making training itself faster and/or more energy efficient. Advantageously, the present embodiments are dynamic and adaptive, do not modify the training algorithm, naturally extend to future algorithms without modifications, and take advantage of value content.

The present embodiments reduce both the energy and time cost of training by leveraging techniques to reduce memory footprint and traffic. Particularly, by selecting an elastic datatype and container, which can be coupled with light-weight encoder/decoder hardware that exploits the datatype and container to reduce off-chip traffic and footprint. The present embodiments provide two lossy, but controlled, techniques to reduce the number of mantissa bits. Since mantissas are normalized and almost uniformly distributed, the mostly noisy, least significant bits are trimmed using either Quantum Mantissa or BitWave. Quantum Mantissa provides a low-overhead modification of gradient descent to “learn” fine-grained (per tensor/layer) mantissa requirements during training. BitWave provides a heuristic based technique that finds the activation mantissas by tracking a current loss function and deciding whether to add, remove, or keep the same the activation mantissa bitlength at network-level granularity. The present embodiments also provide Gecko, a loss-less compression approach for exponents by exploiting their favorable normal distribution by using delta encoding and a fine-grained approach to significantly reduce the exponent footprint of both weights and activation. The present embodiments also provide a hardware architecture that uses the advantageous datatype to deliver energy and performance benefits for neural network training.

Although the invention has been described with reference to certain specific embodiments, various modifications thereof will be apparent to those skilled in the art without departing from the spirit and scope of the invention as outlined in the claims appended hereto.

1. A computer-implemented method of adapting floating-point containers of training data for training an artificial neural network, the method comprising:
receiving the training data for training the artificial neural network;
determining an adapted mantissa bitlength for the training data comprising determining a required number of bits in the mantissas and trimming least significant bits from the mantissas to arrive at the determined number of bits, determining an adapted exponent bitlength for the training data comprising determining a required number of bits in the exponents of the training data and trimming the most significant bits from the exponents to arrive at the determined number of bits, or determining both; and
storing the training data with the adapted mantissa bitlengths, the adapted exponent bitlengths, or both.

2. The method of claim 1, wherein the required number of bits in the mantissa, the required number of bits in the exponent, or both, are determined using gradient descent.

3. The method of claim 2, wherein gradient descent is performed on a per-tensor basis and applied to each activation and weight tensor separately.

4. The method of claim 2, wherein gradient descent is performed with a loss used to penalize mantissa bitlengths, exponent bitlengths, or both, by adding a weighted average of the volume, by weighting a sum based on number of operations on each tensor, or based on a weighted sum of squares.

5. The method of claim 2, wherein determining the required number of bits in the exponents of the training data is determined by parameterizing a range of the exponents, taking partial derivatives of the parameterized range, and determining an exponent bit length gradient using a range for the exponents determined from the partial derivatives.

6. The method of claim 2, wherein determining the required number of bits in the mantissa, or the required number of bits in the exponent, using gradient descent comprises stochastically selecting between two nearest integers.

7. The method of claim 1, wherein the required number of bits in the mantissa is determined by tracking a loss function and using the loss function to determine whether to add, remove, or keep the same the mantissa bitlength.

8. The method of claim 1, wherein the required number of bits in the exponent is determined by tracking a loss function and using the loss function to determine whether to increase, decrease, or keep the same range of exponent values.

9. The method of claim 1, wherein the required number of bits in the exponent is determined by determining a magnitude based on a favorable distribution determined using delta encoding.

10. The method of claim 9, wherein the required number of bits in the exponent is further determined using a bias that is determined from a distribution of exponent values over a group of values.

11. A system of adapting floating-point containers of training data for training an artificial neural network, the system comprising a processing unit and a data storage, the data storage comprising instructions for the processing unit to execute:
an input module to receive the training data for training the artificial neural network;
a mantissa module to determine an adapted mantissa bitlength for the training data comprising determining least significant bits in the mantissas and trimming the least significant bits from the mantissas, an exponent module to determine an adapted exponent bitlength for the training data comprising determining least significant bits in the exponents of the training data and trimming the least significant bits from the exponents, or both the mantissa module and the exponent module; and
an output module to store the training data with the adapted mantissa bitlengths, the adapted exponent bitlengths, or both.

12. The system of claim 11, wherein the required number of bits in the mantissa, the required number of bits in the exponent, or both, are determined using gradient descent.

13. The system of claim 12, wherein gradient descent is performed on a per-tensor basis and applied to each activation and weight tensor separately.

14. The system of claim 12, wherein gradient descent is performed with a loss used to penalize mantissa bitlengths, exponent bitlengths, or both, by adding a weighted average of the volume, by weighting a sum based on number of operations on each tensor, or based on a weighted sum of squares.

15. The system of claim 12, wherein the exponent module determines the required number of bits in the exponents of the training data by parameterizing a range of the exponents, taking partial derivatives of the parameterized range, and determining an exponent bit length gradient using a range for the exponents determined from the partial derivatives.

16. The system of claim 12, wherein determining the required number of bits in the mantissa, or the required number of bits in the exponent, using gradient descent comprises stochastically selecting between two nearest integers.

17. The system of claim 11, wherein the required number of bits in the mantissa is determined by tracking a loss function and using the loss function to determine whether to add, remove, or keep the same the mantissa bitlength.

18. The system of claim 11, wherein the required number of bits in the exponent is determined by tracking a loss function and using the loss function to determine whether to increase, decrease, or keep the same range of exponent values.

19. The system of claim 11, wherein the processing unit comprises encoders to trim the training data using the adapted mantissa bitlengths, the adapted exponent bitlengths, or both, and comprises decoders to expand the training data to the original format.

20. The system of claim 19, wherein the encoder comprises one or more packers that each receive a number and masks unused mantissa bits based on the adapted mantissa bitlengths and unused exponent bits based on the adapted exponent bitlengths.
